(19) United States
(12) Patent Application Publication
(10) Pub. No.: US 2003/0060537 A1
(43) Pub. Date: Mar. 27, 2003

(54) Ink jet ink composition comprising inter-color bleed additive and printing processes using the same

(76) Inventor: Eugene O. Palazzo, Webster, NY (US)

Correspondence Address: OLIFF & BERRIDGE, PLC., P.O. BOX 19928, ALEXANDRIA, VA, 22320, US

(21) Appl. No.: 09/682,603

(22) Filed: Sep. 26, 2001

(51) Int. Cl. C03C 17/00; C09D 5/00

(52) U.S. Cl. 523/160; 523/161

(57) ABSTRACT

An ink jet ink composition including an inter-color bleed additive, such as a polyacrylic or polymethacrylic acid and/or salt additive, an ink jet ink set including at least one such composition and a printing process using such ink jet ink composition for producing high quality multicolor ink jet images having minimal intercolor bleed and relatively low mid frequency line edge noise (MFLEN).

### BACKGROUND OF THE INVENTION

1. Field of Invention

The present invention is directed to an aqueous ink composition. More specifically, the present invention is directed to aqueous ink compositions comprising an inter-color bleed additive, such as a polyacrylic or polymethacrylic acid or similar acid or salt additive, for use with other aqueous inks in multicolor ink jet printing processes.

2. Description of Related Art

Ink jet printing is a non-impact printing method that produces droplets that are deposited on a print substrate (recording medium) such as plain paper, coated paper, transparent film (transparency), or textile in response to electronic digital signals. Thermal or bubble jet drop-on-demand ink jet printers have found broad applications as output for personal computers in the office and at home.

In existing thermal ink jet printing processes, the printhead typically comprises one or more ink jet ejectors, each ejector includes a channel communicating with an ink supply chamber, or manifold, at one end and having an opening at an opposite end, referred to as a nozzle. A thermal energy generator, usually a resistor, is located in each of the channels at a predetermined distance from the nozzles. The resistors are individually addressed with a current pulse to momentarily vaporize the ink within each respective channel to form a bubble that expels an ink droplet. As the bubble grows, the ink rapidly bulges from the nozzle and is momentarily contained by the surface tension of the ink as a meniscus. This is a very temporary phenomenon, and the ink is quickly propelled toward a print sheet. As the bubble begins to collapse, the ink remaining in the channel between the nozzle and the bubble starts to move toward the collapsing bubble, causing volumetric contraction of the ink at the nozzle resulting in the separation of the bulging ink from the nozzle as a droplet. The acceleration of the ink out of the nozzle while the bubble is growing provides sufficient momentum and velocity to propel the ink droplet in a substantially straight line direction towards a print substrate, such as a piece of paper. Subsequently, the ink channel refills by capillary action and is ready for the next repeating thermal ink jet process. Thermal ink jet processes are well known and described in, for example, U.S. Pat. Nos. 4,251,824, 4,410,889, 4,412,224, 4,463,359, 4,532,530, 4,601,777, 5,139,574, 5,145,518, and 5,281,261, the entire disclosures of which are incorporated herein by reference. Because the droplet of ink is emitted only when the resistor is actuated, this type of thermal ink jet printing is known as “drop-on-demand” printing. Other types of drop-on-demand printing such as piezoelectric ink jet printing and acoustic ink jet printing are also known.

Continuous ink jet printing is also known. In continuous ink jet printing systems, ink is emitted in a continuous stream under pressure through at least one orifice or nozzle. Multiple orifices or nozzles can be used to increase imaging speed and throughput. The ink is perturbed while being ejected from an orifice, causing the ink to break up into droplets at a fixed distance from the orifice. At the point of break-up, the electrically charged ink droplets pass through an applied electrode that switches on and off in accordance with digital data signals. Charged ink droplets pass through a controllable electric field that adjusts the trajectory of each ink droplet in order to direct it to either a gutter for ink deletion and recirculation or to a specific location on a recording substrate to create images.

In an ink jet printing apparatus, the printhead typically comprises a linear array of ejectors, and the printhead moves relative to the surface of the print substrate, either by moving the print substrate relative to a stationary printhead, or vice-versa, or both. In some types of apparatuses, at least a relatively small print head supplied with an ink moves across a print sheet numerous times in swaths in order to complete an image. For multicolor ink jet printing, a set of printheads and ink (e.g. cyan, magenta, yellow and black) can move across the print substrate numerous times in swathes and disperse selected inks in any desired pattern (e.g., ⅛, ¼, ½, fulltone (1/1)) according to digital signals. The speed of this type of single or multiple color ink jet printing on a substrate is determined by the moving speed of the printheads across the print substrate, ink jetting frequency (or frequency response), and the desired number of swathes needed for printing. The printing speed of this type of ink jet apparatus can be increased if two or more print heads are budded together to form a partial-width array printhead for printing each ink in a monochrome or multicolor ink jet printing system. The partial-width ink jet printhead has more ink jet nozzles per printhead, and can deliver a large number of ink droplets across the substrate in a swath in a short period of time. Monochrome or multicolor ink jet printing apparatuses using one or several partial-width printheads may have a faster printing speed than current commercial ink jet printers.

Alternatively, a printhead that consists of an array of ejectors (e.g., several butted printheads to give a full-width array printhead) and extends the full width of the print substrate may pass an ink down once onto the print substrate to give full-page images, in what is known as a “full-width array printer”. When the printhead and the print substrate are moved relative to each other, image-wise digital data is used to selectively activate the thermal energy generators in the ink jet printhead over time so that the desired image will be created on the print substrate at a fast speed. For multicolor ink jet printing, several full-width array printheads and inks (e.g., cyan, magenta, yellow, and black) can be used to deliver multiple color inks onto a print sheet. This type of multicolor ink jet printing process is capable of printing multiple color images and monochrome color images on a print substrate at a much faster speed (e.g., more than five pages of full color images per minute) than current commercial color ink jet printers.

In multicolor ink jet printing processes, several inks can be printed on a print substrate. In some instances, two different inks can be printed next to each other. Intercolor bleed can occur if the inks are not dried properly or if the printing process is too fast for the inks to set. Undesired ink mixing on a print substrate, especially on the surface of a plain paper, can cause distorted images near the border of two inks. After the inks dry, the border of the two inks can appear irregular with poor edge sharpness (or raggedness) due to the invasion of one ink into the other. Such bleed images are visibly unattractive. This phenomenon is generally called intercolor bleed. Intercolor bleed occurs particularly when a darker colored ink (such as a black ink) and a lighter colored ink (such as a yellow ink, a cyan ink, a magenta ink, or the like) are printed next to each other, because of the high contrast between the two colors. Intercolor bleed can also occur when two color inks are printed next to each other (for example yellow ink next to magenta ink, yellow ink next to cyan ink, magenta ink next to cyan ink or the like). The severity of the intercolor bleed generally is affected by the type and composition, absorption rate of the printer substrate, printhead design, ink drop mass, ink dot size and method and speed of printing. As a result, there is a need to reduce intercolor bleed and to produce high quality multicolor ink jet images on print substrates, including plain and coated papers, transparencies, textiles and other desired substrates.

U.S. Pat. No. 5,091,005, the disclosure of which is totally incorporated herein by reference, discloses inks comprising, by weight, from about 4% to about 10% formamide, from about 1% to about 10% dye, and the balance water, that when printed on paper from an ink jet printer exhibit improved resistance to bleed, especially when printed at a rate up to about 3.7 kHz.

U.S. Pat. No. 5,116,409, the disclosure of which is totally incorporated herein by reference, discloses the alleviation of color bleed (the invasions of one color into another on the surface of a print medium) using ink jet inks by employing zwitterionic surfactants (pH-sensitive or pH-insensitive) or ionic or nonionic amphiphiles. The inks comprise a vehicle and a dye. The vehicle typically comprises a low viscosity, high boiling point solvent, one or two amphiphiles at concentrations above their critical micelle concentration (cmc), while the dye typically comprises any of the dyes commonly employed in ink jet printing. The amount of surfactant/amphiphile is described in terms of its critical micelle concentration (cmc), which is a unique value for each amphiphile. Above the cmc, micelles form, that attract the dye molecule and thus control the color bleed. Below the cmc, there is no micelle formation, and thus no control of the color bleed.

U.S. Pat. No. 5,106,415, the disclosure of which is totally incorporated herein by reference, discloses the alleviation of color bleed using ink jets by employing zwitterionic surfactants (pH-sensitive or pH-insensitive) or ionic or nonionic amphiphiles. The inks of the invention comprise a vehicle and a cationic dye. The vehicle typically comprises a low viscosity, high boiling point solvent, one or two amphiphiles at concentrations above their critical micelle concentration (cmc), while the dye typically comprises any of the dyes commonly employed in ink jet printing. The amount of surfactant/amphiphile is described in terms of critical micelle concentration (cmc), which is a unique value for each amphiphile. Above the cmc, micelles form, which attract the dry molecule and thus control the color bleed. Below the cmc, there is no micelle formation, and thus no control of the color bleed.

U.S. Pat. No. 5,133,803, the disclosure of which is incorporated herein by reference in its entirety, discloses the control of color bleed using ink jet inks employing high molecular weight colloids, such as alignates, in conjunction with amphoteric surfactants and/or nonionic amphiphiles. The inks disclosed comprise a vehicle and a dye. The vehicle typically comprises a low viscosity, high boiling point solvent and one or two surfactants at concentrations above their critical micelle concentration (cmc), while the dye typically comprises any of the dyes commonly employed in ink jet printing. The amount of surfactant is described in terms of critical micelle concentration (cmc), which is a unique value for each surfactant system. Above the cmc, colloidal species form, which attract the dye molecules and thus control color bleed. Below the cmc, there is no colloid formation, and thus poor control of color bleed.

U.S. Pat. No. 5,181,045, the disclosure of which is incorporated herein by reference in its entirety, discloses certain dyes that become insoluble under specific and well-defined pH conditions. By forcing a dye to become insoluble on the page, migration of the dye is inhibited, thereby helping to reduce bleed between inks of different colors. The dye is forced out of solution from the ink by contact with another ink having the appropriate pH (either higher or lower than the first ink).

U.S. Pat. No. 5,320,668, the disclosure of which is incorporated herein by reference in its entirety, discloses certain colorants that become insoluble under specific and well-defined pH conditions. By forcing a colorant to become insoluble on the page, migration of the colorant is inhibited, thereby helping to reduce color bleed between inks of different colors. The colorant is forced out of solution from the ink by contact with another ink having the appropriate pH (either higher or lower than the first ink). In particular, an ink containing a colorant comprising a pigment in combination with a pH sensitive dispersant is used in conjunction with an ink of the appropriate pH.

U.S. Pat. No. 5,342,440, the entire disclosure of which is incorporated herein by reference, discloses water insoluble black dyes that are formulated in a microemulsion black ink. When printed adjacent to color inks (yellow, magenta, cyan) containing water soluble dyes, bleed does not occur between the black and color dyes.

U.S. Pat. No. 5,476,540, the entire disclosure of which is incorporated herein by reference, discloses a method for controlling color bleed between adjacent multicolor ink regions on a print medium. A first composition containing a gel species and a color agent is brought into contact on a region of the print medium with a second composition having a color agent and a gel initiating species or chemical conditions which bring about gelation. In alternative embodiments, the print medium can be pretreated with either a gel forming species or a gel initiating species (with colorant), respectively. The formation of the gel upon the print medium impedes the movement of the color agent or agents and thus reduces the color bleed between adjacent zones in a multicolored printed image on a print medium.

U.S. Pat. No. 5,531,817, the entire disclosure of which is incorporated herein by reference, discloses the control of color bleed using ink jet inks by employing either high molecular weight polymers that exhibit a reversible gelling nature with heat or certain amine oxide surfactants that undergo sol-gel transitions. The inks further include a vehicle and a dye. The vehicle typically comprises a low viscosity, high boiling point solvent and water. Certain high molecular weight polymers, under the correct solution conditions, can form gels which can be subsequently melted by heating of the gel. When the melted gel is cooled, it reforms into a gel. The viscosity of an ink employing a gel can then decrease to a viscosity low enough to permit jetting from the print cartridge. After leaving the print cartridge, the melted gel again reforms into a highly viscous gel to immobilize the droplet of ink and prevent migration on the media. Therefore, two drops of different colors, when printed next to each other are inhibited from migrating or bleeding into one another.

U.S. Pat. No. 5,565,022, the entire disclosure of which is incorporated herein by reference, discloses ink jet ink compositions that exhibit fast dry times and bleed free prints when printed onto a print medium so that the throughput of an ink jet printer can be increased. The ink compositions comprise (a) at least one dye; (b) at least one high boiling, water insoluble organic compound; (c) at least one amphiphile; and (d) water. The dye can be either water-soluble or water-insoluble and the high boiling point organic compound has a vapor pressure low enough so that only water evaporates from the ink during normal printing operations. The amphiphile is present in amount sufficient to solubilize the water-insoluble organic compound in the water. Preferably, the amphiphile belongs to a class of compounds known as the hydrotropes.

U.S. Pat. No. 5,198,023, the entire disclosure of which is incorporated herein by reference, discloses an ink set in which bleed between yellow and black inks is reduced by using a cationic yellow dye in the yellow ink and an anionic dye in the black ink. Bleed is further reduced by adding a multivalent precipitating agent to the yellow ink. With regard to bleed between yellow and other color inks (cyan and magenta), bleed is reduced by also employing anionic dyes in the other color inks.

U.S. Pat. No. 5,428,383 and U.S. Pat. No. 5,488,402, the entire disclosures of which are incorporated herein by reference, disclose a method for controlling color bleed in multicolor thermal ink jet printing systems. To control color bleed between any two ink compositions in a multi-ink system, at least one of the ink compositions will contain a precipitating agent (such as a multivalent metal salt). The precipitating agent is designed to react with the coloring agent in the other ink composition of concern. As a result, when the two ink compositions come in contact, a precipitate forms from the coloring agent in the other ink composition that prevents migration thereof and color bleed problems. This technique is applicable to printing systems containing two or more ink compositions, and enables distinct multicolor images to be produced without the problems normally caused by color bleed.

U.S. Pat. No. 5,518,534, the entire disclosure of which is incorporated herein by reference, discloses an ink set for alleviating bleed in multicolor printed elements employing a first ink and a second ink, each containing an aqueous carrier medium and a colorant; the colorant of the first ink being a pigment dispersion and the second ink containing a salt of an organic acid or mineral acid having a solubility of at least 10 parts in 100 parts of water at 25° C.

U.S. Pat. No. 5,250,107, the entire disclosure of which is incorporated herein by reference, discloses a water-fast ink composition and a method of making the same. A selected chemical dye having at least one functional group with an extractable hydrogen atom thereon (such as —COOH, —NH₂, or —OH) is combined with an ammonium zirconium polymer salt (such as ammonium zirconium carbonate, ammonium zirconium acetate, ammonium zirconium sulfate, ammonium zirconium phosphate, and ammonium zirconium oxalate). The resulting mixture preferably contains about 0.01-5.0% by weight ammonium zirconium polymer salt and about 0.5-5.0% by weight chemical dye. Upon dehydration of the mixture, the ammonium zirconium polymer salt and chemical dye form a cross-linked dye complex that is stable and water-fast. The mixture can be dispensed into a variety of substrates (e.g. paper) using thermal ink jet or other printing systems.

U.S. Pat. No. 4,267,088, the entire disclosure of which is incorporated herein by reference, discloses coatings particularly useful as marking inks in which an epichlorohydri-modified polyethyleneimine and ethylene oxide-modified polyethyleneimine cooperate in aqueous solution to form a composition capable of application to form deposits adherent to most materials and resistant to most organic solvents but readily removed by water.

U.S. Pat. No. 4,197,135, the entire disclosure of which is incorporated herein by reference, discloses an ink for use in ink jet printers containing a water soluble dye and a polyamine containing 7 or more nitrogen atoms per molecule, with the ink composition having a pH of 8 or above, the pH limit being dye composition dependent. The ink has improved waterfastness over an equivalent ink formulation without the polyamine additive.

U.S. Pat. No. 4,659,382, the entire disclosure of which is incorporated herein by reference, discloses an ink jet composition comprising a major amount of water, a hydroxyethylated polyethyleneimine polymer, and a dye component, wherein the polymer has incorporated therein from about 65 to about 80 percent by weight of the hydroxyethyl groups.

U.S. Pat. No. 5,693,129, the disclosure of which is totally incorporated herein by reference, discloses an ink jet ink composition that comprises water; a colorant selected from the group consisting of a dye, a pigment, and a mixture of a dye and a pigment; and a material selected from the group consisting of (1) a hydroxyamide derivative having at least one hydroxyl group and at least one amide group; (2) a mercaptoamide derivative having at least one mercaptol group and at least one amide group; (3) a hydroxythioamide derivative having at least one hydroxyl group and at least one thioamide group; (4) a mercaptothioamide derivative having at least one mercaptol group and at least one thioamide group; (5) an oxyalkylene (alkyleneoxide) reaction product of the above derivatives; (6) a thioalkylene (alkylenesulfide) reaction product of the above said derivatives; and (7) mixtures thereof. The inks comprising the ink jet composition exhibit good latency especially in a high resolution thermal ink jet printhead (e.g. 600 spi) and can be printed onto a print substrate either with or without heat for the drying to give excellent images with reduced curl and cockle.

Japanese Patent publication 57-198768, the entire disclosure of which is incorporated herein by reference, discloses a type of water-base ink made of acidic dye and/or direct dye, cationic water-soluble resin, water-soluble organic solvent and water.

Further, although carbon black inks, are capable of producing good quality black images on North American and Japanese plain paper, they are not used as mainline black inks in multicolor printing process because they have tendency to exhibit poor intercolor bleed performance when printed next to color inks. The poor intercolor bleed performance of such inks is especially evident when such inks are printed next to yellow colored inks due to the high level of color contrast. In addition, although other black inks exhibit suitable intercolor bleed performance, these inks exhibit poor mid frequency line edge noise (MFLEN) data on Japanese paper.

Therefore, although the above compositions and processes are suitable for their intended purposes, there remains a need for improved multicolor thermal ink jet printing processes. In addition, a need remains for multicolor thermal ink jet printing processes wherein the print generated exhibits reduced intercolor bleed. Further, a need remains for multicolor thermal ink jet printing processes wherein the prints generated exhibit excellent image quality. In particular, there is an urgent need for an ink (especially a color ink) that provides good MFLEN (mid frequency line edge noise) and intercolor bleed performance when printed together with black inks to form multicolor images.

### SUMMARY OF THE INVENTION

The present invention is directed to an ink jet ink composition that comprises an inter-color-bleed additive, such as a polyacrylic or polymethacrylic acid and/or a salt or salts thereof or a structurally similar compound, a multicolor ink jet ink set that includes such a composition and a multicolor ink jet printing process using such an ink composition. In particular, the present invention is directed to a color ink jet ink composition comprising an inter-color bleed additive such as a polyacrylic or polymethacrylic acid and/or salt additive, an ink jet ink set comprising at least one such composition and multicolor ink jet printing process using such a composition, wherein when printed with a carbon black ink the composition minimizes intercolor bleed and maintains MFLEN.

### DETAILED DESCRIPTION OF PREFERRED EMBODIMENTS

According to the present invention, at least one ink in a multicolor ink jet printing process comprises a specified inter-color bleed additive to minimize intercolor bleed that typically occurs when printing a multicolor image onto a print substrate (e.g. plain paper).

According to the present invention, the inter-color bleed additive is an acid or salt thereof, where the acid can generally be any suitable acid having one or more pendant carboxylic acid groups and/or one or more carboxylate groups. For example, suitable inter-color bleed additives include polymers formed from monomers having one or more pendant —COOR groups, where R can be hydrogen; methyl, ethyl or other substituted or unsubstituted alkyl groups having from about 1 to about 12 carbon atoms; carboxyl groups having from about 1 to about 12 carbon atoms; cyclic groups including phenyl groups, and the like. Suitable monomers thus include, but are not limited to, acrylic acid, methacrylic acid, methyl acrylic acid, methyl methacrylic acid, itaconic acid, and the like.

Particularly suitable inter-color bleed additives according to the present invention are poly(meth)acrylic acid and salts thereof. The term “poly(meth)acrylic” indicates that either or both of polyacrylic and polymethacrylic can be used. The poly(meth)acrylic acid or salt additive in the ink jet ink composition of the present invention is generally very weakly soluble in water, but is generally soluble in a basic medium (such as an aqueous alkali or amine solution).

According to the present invention, when the additive is in the form of a salt, the poly(meth)acrylic acid or other material can be complexed with any suitable counter cation, which can be either monovalent or divalent, as desired. Thus, for example, suitable counter cations include, but are not limited to, hydrogen (H⁺); alkali metals such as Li⁺, Na⁺, K⁺, Rb⁺, Cs⁺, and the like; alkaline earth metals such as Be²⁺, Mg²⁺, Ca²⁺, Sr²⁺, Ba²⁺, and the like; ammonium cations such as substituted and unsubstituted ammonium cations that can optionally include H⁺, alkyl groups, heterocyclic groups, and mixtures thereof; mixtures thereof; and the like. For example, suitable ammonium salts include, but are not limited to, ammonium; C₁-C₁₂-ammonium, preferably C₁-C₄-ammonium such as methylammonium, ethylammonium, and the like; di(C₁-C₁₂)ammonium, preferably di(C₁-C₄)ammonium such as dimethylammonium, diethylammonium, and the like; tri(C₁-C₁₂)ammonium, preferably tri(C₁-C₄)ammonium such as trimethylammonium, triethylammonium, and the like; quaternary ammoniums including tetra(C₁-C₁₂)ammonium, preferably tetra(C₁-C₄)ammonium such as tetramethylammonium, tetraethylammonium, tetrabutylammonium, and the like; mopholinium; imidazolium; pyridinium; and the like. Examples of suitable substituted ammonium salts include, for example, hydroxy- or alkoxy-substituted ammonium salts such as, for example, 2-hydroxyethylammonium, bis(2-hydroxyethyl)-ammonium, tris(2-hydroxyethyl)-ammonium, bis(2-hydroxyethyl)-methylammonium, tris(2-(2-methoxyethoxy) ethyl)-ammonium, and the like. Other suitable cations include but are not limited to di(C₁-C₁₂)piperidinium, preferably di(C₁-C₄) piperidinium such as dimethylpiperidinium, and the like; those derived from alkylamines such as ethylamine, diethylamine, triethylamine, and the like; mixtures thereof; and the like.

Where polymer materials are used as the additive, the polymer materials preferably have a number average molecular weight of from about 2,000 to about 25,000. In embodiments, the number average molecular weight of the polymer materials is from about 3,000 to about 20,000, more preferably from about 4,000 or about 5,000 to about 10,00 or about 15,000. However, higher or lower molecular weight materials can be used, if desired.

According to embodiments of the present invention, suitable poly(meth)acrylic acid salts thus include, but are not limited to, polyacrylic acid lithium salt, polymethacrylic acid lithium salt, polyacrylic acid sodium salt, polymethacrylic acid sodium salt, polyacrylic acid potassium salt, polymethacrylic acid potassium salt, polyacrylic acid cesium salt, polymethacrylic acid cesium salt, polyacrylic rubidium salt, polymethacrylic rubidium salt, polyacrylic acid ammonium salt, polymethacrylic acid ammonium salt, polyacrylic acid tetramethylammonium salt, polymethacrylic acid tetramethylammonium salt, polyacrylic acid trimethylammonium salt, polymethacrylic acid trimethylammonium salt, polyacrylic acid tetraethylammonium salt, polymethacrylic acid tetraethylammonium salt, polyacrylic acid mopholinium salt, polymethacrylic acid mopholinium salt, polyacrylic acid imidazolium salt, polymethacrylic acid imidazolium salt, polyacrylic acid pyridinium salt, polymethacrylic acid pyridinium salt, and the like as well as mixtures thereof. Likewise, suitable itaconic acid salts include any of the foregoing materials, where the poly(meth)acrylic acid is replaced by itaconic acid.

Furthermore, in the case of the counter cations for the poly(meth)acrylic acid polymer chain, the counter cations can be the same or different for the various monomer segments. Accordingly, the poly(meth)acrylic acid macromolecule can have mixed or unmixed cations associated with a macromolecular chain of polyacrylic acid anions in the ink medium. Likewise, the ink jet ink composition can include two or more different types of poly(meth)acrylic acid salts, if desired.

In embodiments, it is preferred that the polymeric macromolecule as the inter-color bleed additive can have mixed cations, i.e., multiple different cations. The mixed cations of the additive salts, such as polyacrylic acid salts, are preferred in embodiments because they have great affinity with water and pose little risk of crystallization. Moreover, the mixed cations of the polyacrylic acid salts of the present invention are also advantageous because they are able to avoid premature crusting and/or clogging of ink jet printer printheads. The anti-crusting/clogging properties of the mixed cations of the polyacrylic acid salts of the present invention are especially important in high-resolution ink jet printheads, e.g. printheads with a resolution greater than or equal to about 360 spi, such as about 400 spi or greater or about 600 spi or greater.

Still further, the ink jet ink composition comprising the above additive materials provides the further benefit that ink jet ink images printed using the inks exhibit some level of waterfastness, especially on acidic substrates such as acidic papers. Thus, in embodiments, waterfastness improving additives can be included in the ink compositions in a lesser amount, or omitted entirely. At the same time, the poly(meth)acrylic acids are also generally compatible with various conventional ink jet ink composition additives including, but not limited to, humectants, pH buffering agents and anti-clogging agents.

In embodiments of the present invention, the inter-color bleed additive of the present invention is present in an effective amount to provide the desired effect of reduced intercolor bleed, without sacrificing print quality or printing characteristics of the ink composition. Thus, for example, the additives can be present in an amount from about 0.1 percent to about 5.0 percent by weight of the ink composition. Preferably, the inter-color bleed additive is present in an amount from about 0.5 percent to about 2.0 percent, by weight of the ink composition. However, amounts outside of these ranges can be used, as desired.

The present invention is also directed to an ink set, for example, 2, 3, 4 or more different colored inks. The ink jet ink set of the present invention can include various different colored inks. In an exemplary embodiment, the ink jet ink set of the present invention comprises a cyan ink, a magenta ink, a yellow ink and a black ink, wherein at least one of such inks comprises the above-described inter-color bleed additive. The ink jet ink set of the present invention preferably includes at least one ink comprising an inter-color bleed additive, more preferably at least two inks comprising the inter-color bleed additive, even more preferably at least three inks comprising the additive, and most preferably at least four inks or more comprising the additive.

Preferably, according to the present invention, the inter-color bleed additive is incorporated into a colored ink of an ink set in preference to a black ink of the ink set. Thus, for example, where an ink set includes four inks colored cyan, magenta, yellow and black, the inter-color bleed additive is preferably incorporated into one or more of the cyan, magenta and yellow inks, and is not incorporated into the black ink. However, in embodiments, it may also be preferred to incorporate the additive into the black ink, either in addition to or in place of incorporation into one of the other colored inks.

The multicolor ink jet printing process of the present invention can include various steps. For instance, the printing process of the present invention may or may not include a step of heating the print substrate before, during or after printing to enhance the print quality of the resulting images. The printing process of the present invention can also include waiting for a duration of time between printing black and color inks to improve image print quality. The color ink composition of the present invention can be printed over, under or near the border of another ink (e.g. a dye or carbon black ink, or another color ink) using any pixel management (e.g. ⅛ tone, ¼ tone, ½ tone, pixel substitution of another ink, etc.) to enhance image quality and performance (e.g. optical density, reduced intercolor bleed and reduced dry time).

The printing process of the present invention can also include printing inks in various printing sequences (e.g. yellow, cyan, magenta, black; yellow, magenta, cyan, black; black, cyan, magenta, yellow; black, magenta, cyan, yellow; etc.) to reduce intercolor bleed.

Also, a black ink used in the process of the present invention can be either a dye-based ink or a pigment-based ink. Pigment-based black inks used in the printing process of the present invention, such as chemically modified carbon black dispersions, can comprise carbon black particles stabilized by a dispersant (e.g. sulfonate, carboxylate, phosphate group(s), and mixtures thereof). Further, a black ink used in the process of the present invention can be printed next to at least one color ink comprising either a polyacrylic acid and/or salt additive, or a polymethacrylic acid and/or salt additive to obtain high quality mutlicolor images on a print substrate (e.g. plain papers, coated papers, ink jet transparencies, etc.) that exhibit minimal intercolor bleed.

According to the present invention the polyacrylic or polymethacrylic acid and/or salt additive can be included in one or more inks of an ink set. In addition, such additives can be incorporated into an ink jet ink that is used in a monocolor printing apparatus. Thus, for example, the present invention applies equally to a printing apparatus that prints multicolor images, as well as to a printing apparatus that prints only a single-color image. However, it will be appreciated that the benefits provided by the present invention are particularly applicable to multicolor printing, where intercolor bleed reduction is a great concern.

Also, according to the present invention, the inter-color bleed additive can be included in any one or more of the various colored inks in an ink set. Thus, for example, the additives can be included in one or more of the inks, such as the black, magenta, yellow or cyan inks. However, particular benefits are provided by the present invention when the additives are included in color inks, such as magenta, yellow or cyan inks, printed together with black inks in multicolor ink jet printing processes.

The printing process of the present invention can also be conducted using many different printers employing various printing methods including, but not limited to, thermal ink jet printing, acoustic ink jet printing, continuous stream ink jet printing, and piezoelectric ink jet printing. In addition, the present invention can also comprise jetting at least one ink through a printhead capable of printing at least about 360 spots per inch, preferably at least about 400 spots per inch, more preferably at least about 500 spots per inch, and most preferably at least 600 spots per inch or more.

The ink composition of the present invention can also be used in conjunction with various ink additives including, but not limited to, anti-clogging agents, polymeric additives, anti-kogation additives, anti-curl agents, humectants, biocides, anti-bleed agents and pH buffering agents.

The ink composition of the present invention can also include various anti-clogging agents to prevent clogging. Suitable anti-clogging agents include but are not limited to polyethyleneglycol, polypropyleneglycol, poly(ethylene-co-propylene) glycol, polyhydric materials (materials containing more than one hydroxyl group), condensation products of diols or triols (glycerine, trimethylolpropane, triethanolamine, etc.) with ethyleneoxide and/or propyleneoxide.

Various anti-clogging agents can also serve as latency enhancers to increase the latency of the ink of this invention. Long latency is preferred so that the ink does not clog the nozzle of the printhead and reduce the need for frequent printhead maintenance.

Various polymeric binders can also be used in conjunction with the ink composition of the present invention to adjust the viscosity of the composition. Suitable polymeric binders include, but are not limited to, water soluble polymers and copolymers such as gum arabic, polyacrylate salts, polymethacrylate salts, polyvinyl alcohols, hydroxypropylenecellulose, hydroxyethylcellulose, polyvinylpyrrolidinone, polyvinylether, starch, polysaccharides, polyethyleneimines with or without being derivatized with ethylene oxide and propylene oxide including the Discole® series (DKS International); the Jeffamine® series (Texaco); and the like. Polymeric additives may be present in the ink jet inks of the present invention in amounts from 0 to about 10% by weight of the total ink weight, preferably from about 0.001 to about 8% by weight of the total weight of the ink, and more preferably from about 0.01 to about 5% by weight of the total ink weight, although the amount can be outside these ranges.

The ink jet composition of the present invention can also comprise various anti-curl and/or anti-cockle agents. Suitable agents include, but are not limited to, those disclosed in U.S. Pat. No. 5,356,464 to Hickman et al. and U.S. Pat. No. 5,207,824 to Moffatt et al.

Various humectants can be used in the ink composition of the present invention. Suitable humectants and co-solvents include, but are not limited to, glycol derivatives, including ethylene glycol, diethylene glycol, propylene glycol, dipropylene glycol, polyethylene glycol, polypropylene glycol, poly(ethylene-co-propylene) glycol, and the like, as well as their reaction products with alkylene oxides, including ethylene oxides, including ethylene oxide and propylene oxide; triol derivatives containing from about 3 to about 40 carbon atoms, including glycerine, trimethylpropane, 1,3,5-pentanetriol, 1,2,6-hexanetriol, and the like as well as their reaction products with alkylene oxides, including ethylene oxide, propylene oxide, and mixtures thereof; diols containing from about 2 to about 40 carbon atoms, such as 1,3-pentanediol, 1,4-butanediol, 1,5-pentanediol, 1,4-pentanediol 1,6-hexanediol, 1,5-hexanediol, 2,6-hexanediol, neopentylglycol (2,2-dimethyl-1,3-propanediol, neopentylglycol, (2,2-dimethyl-1,3-propaediol), and the like, as well as their reaction products with alkylene oxides, including ethylene oxide and propylene oxide in any desirable molar ratio to form materials with a wide range of molecular weights; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like; amides with from about 2 to about 40 carbon atoms, such as N-alkylamides, N,N-dialkyl amides, N,N-alkyl phenyl amides, 2-pyrrolidone (a cyclic amide), n-methylpyrrolidone (a cyclic amide), N-cyclohexylpyrrolidone, N,N-dimethyl-p-toluamide (aromatic), N,N-dimethyl-o-toluamide, N,N-diethyl-m-toluamide, and the like; ethers, such as alkyl ether derivatives of various alcohols, ether derivatives of triols and diols, including butylcarbitol, hexylcarbitol, triolethers, alkyl ethers of polyethyleneglycols, alkyl ethers of polypropyleneglycols, alkyl ethers of phenylpolyethyleneglycols, and the like; urea and urea derivatives; inner salts such as betaine, and the like; thio (sulfur) derivatives of the aforementioned materials (humectants), including thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy-propanolamine, and the like; reaction products of the aforementioned materials (humectants) with alkylene oxides; and mixtures thereof.

Further examples of suitable humectants are disclosed, for example, in U.S. Pat. Nos. 5,281,261, 5,531,818, 5,693,129, 4,840,674, 5,365,464, copending application U.S. Ser. No. 08/782,237, and copending application U.S. Ser. No. 08/876,410, the disclosures of which are incorporated herein by reference in their entireties.

The ink composition of the present invention can also comprise various anti-bleed agents and/or drying accelerating agents to reduce intercolor bleed. Suitable agents include, but are not limited to, penetrants including hydroxyethers, including alkyl cellusolves® and alkyl carbitols® such as hexyl carbitol® and butyl carbitol; polyethylene glycol ether derivatives (such as alkyl ethers including methyl, ethyl, propyl, butyl, pentyl, hexyl, dodecyl, lauryl, stearyl, ether derivatives, phenyl and alkylphenyl ether derivatives of polyethyleneglycols, and the like); and polypropyleneglycol ether derivatives (such as alkyl ethers including methyl, ethyl, propyl, butyl, pentyl, hexyl, dodecyl, lauryl, stearyl ether derivatives, phenyl and alkylphenyl, ether derivatives of polypropylene glycols, and the like); and the like, and mixtures thereof.

Various pH buffers can also be included in the ink composition of the present invention. Suitable pH buffers include, but are not limited to, acids, bases, phosphate salts, carboxylate salts, sulfite salts, sulfate salts, amine salts, and the like. Such pH controlling agents are generally present in an amount from 0 to about 10% by weight of the ink, preferably from about 0.001 to about 5% by weight of the ink and more preferably from about 0.01 to about 5% by weight of the ink, although the amount can be outside of these ranges.

The ink composition of the present invention can also include various biocides. Suitable biocides include, but are not limited to, biocides such as Dowicil® 150, 200, and 75, benzoate salts, sorbate salts, Proxcel® (available from ICI), and the like. When used, such biocides are generally present in an amount from 0 to about 10% by weight of the ink, preferably from about 0.001 to about 8% by weight of the ink, and more preferably from about 0.01 to about 4% by weight of the ink, although the amount can be outside of these ranges.

The following examples describe exemplary embodiments of the present invention. These examples are merely illustrative, and in no way limit the present invention to the specific materials, conditions or process parameters set forth therein. All parts and percentages are by weight unless otherwise indicated.

### EXAMPLES

The following is a list of examples.

### Comparative Yellow Ink 1

An unmodified yellow ink is provided comprising acid yellow 23, sulfolane, butylcarbitol, acetylethanolamine, polyethyleneoxide, urea, imidazole, Dowicil 200, and water. The unmodified yellow ink is then printed on plain paper and used as a reference or control.

### Example Yellow Ink 1

An yellow ink is prepared according to the present invention. The ink is prepared using the same materials and amounts as the Comparative Ink 1 above, except that the ink is modified by adding 1% polyacrylic acid sodium salt (number average molecular weight about 5,100). The pH of the ink is adjusted to 7.45. The properties of the modified ink are as follow: γ=38.5 dyne/cm and η=3.71 cp, as measured at 25° C.

### Black Ink

A black ink is prepared comprising 19.48% Cabot Carbon Black dispersion (a chemically modified carbon black dispersion from Cabot Corp., 15% solid content), 10.53% sulfone (contains 5% water, Philips), 8.5% 2-Pyrrolidone, 3.5% polyether-polymethylsiloxane copolymer (Tegropren 5884, 35% solid), 1.43% latex (35% solid, benzyl methacrylate/ethylene glycol methacrylate/methacrylate), 0.05% polyethyleneoxide, and balance water (deionized water).

### Example 1

A Hewlett Packard HP 855C ink jet printer (600 spi for black ink and 300 spi for color inks (e.g. cyan, magenta and yellow inks)) is operated in either “Normal Mode” or “Best Mode”. The above-prepared black ink is used to print on a wide variety of plain papers alone and/or next to either the Comparative Yellow Ink or the Example Yellow Ink. Intercolor bleed data between the black and yellow inks are measured for comparison. The results are shown in Tables 1 and 2 below. Cyan and magenta inks are also used in preparing multicolor ink jet images.

Table 1 shows the significant improvement in intercolor bleed performance of the ink of the present invention (Example Yellow Ink) as compared with the performance of the conventional ink (Comparative Yellow Ink).

TABLE 1
Comparison of Intercolor Bleed Data of Example and Comparative
Yellow Inks Against Black Ink

| | Intercolor Bleed of | | Intercolor Bleed of | |
|---|---|---|---|---|
| | Comparative Ink | | Example Ink | |
| | Against Black Ink | | Against Black Ink | |
| | Horizontal | | Horizontal | |
| Paper Type | Mode | Vertical Mode | Mode | Vertical Mode |
| 3 NT | 69.7 | 48.9 | 52 | 25.9 |
| 7 NT | 10.3 | 10.5 | 8.5 | 15.5 |
| 10 NT | 20.2 | 21.5 | 18 | 16.7 |
| 18 NT | 84.4 | 75 | 42.3 | 36.1 |
| Xerox Recycle | 83.6 | 77.8 | 16.1 | 21.5 |
| Average | 52 | 44.2 | 48.2 | 22.2 |

* Note: HP 855C Printer was used in Normal Mode

TABLE 2
Reduction of Intercolor Bleed of Example Ink on Japanese Papers
By Printing In Best Mode

| | Intercolor Bleed of | | Intercolor Bleed of | |
|---|---|---|---|---|
| | Example Ink | | Example Ink | |
| | Against Black Ink | | Against Black Ink | |
| | (Normal Mode) | | (Best Mode) | |
| | Horizontal | | Horizontal | |
| Paper Type | Mode | Vertical Mode | Mode | Vertical Mode |
| CJ-3 | 38.4 | 34 | 28.1 | 25.1 |
| CJ-9 | 39.7 | 23.8 | 23.1 | 18.8 |
| CJ-11 | 32.8 | 23 | NA | NA |
| Fuji Xerox | 28 | 22 | 17.7 | 14.4 |
| Kakusaku L | | | | |
| Average | 34.7 | 25.9 | 23 | 19.4 |

What is claimed is:

1. An ink jet ink composition for multicolor ink jet printing, wherein the ink composition comprises:
an inter-color bleed additive;
a colorant; and
an ink vehicle,
wherein the inter-color bleed additive is an acid or salt thereof, the acid having at least one pendant carboxylic acid group or at least one pendant carboxylate group.

2. The composition of claim 1, wherein the inter-color bleed additive comprises a polymer formed from monomers having one or more pendant —COOR groups, where R is selected from the group consisting of hydrogen; substituted or unsubstituted alkyl groups having from about 1 to about 12 carbon atoms, carboxyl groups having from about 1 to about 12 carbon atoms, and cyclic groups.

3. The composition of claim 1, wherein the inter-color bleed additive is selected from the group consisting of polyacrylic acid, polymethacrylic acid, polymethylacrylic acid, polymethylmethacrylic acid, polyitaconic acid, and salts thereof.

4. The composition of claim 1, wherein the inter-color bleed additive is selected from the group consisting of polyacrylic acid, polymethacrylic acid, and salts thereof.

5. The composition of claim 1, wherein the inter-color bleed additive is present in an amount ranging from about 0.1 to about 5.0 percent by weight of the total weight of the composition.

6. The composition of claim 1, wherein the inter-color bleed additive comprises at least one of a polyacrylic or polymethacrylic acid or salt thereof.

7. The composition of claim 1, wherein the inter-color bleed additive is a salt of a counter ion selected from the group consisting essentially of H⁺, Li⁺, Na⁺, K⁺, RB, Cs⁺, Be²⁺, Mg²⁺, Ca²⁺, Sr²⁺, Ba²⁺, and substituted or unsubstituted ammonium ions.

8. The composition of claim 1, wherein the colorant is a dye.

9. The composition of claim 1, wherein the colorant is a pigment.

10. The composition of claim 1, wherein said inter-color bleed additive is selected from the group consisting essentially of polyacrylic acid lithium salt, polymethacrylic acid lithium salt, polyacrylic acid sodium salt, polymethacrylic acid sodium salt, polyacrylic acid potassium salt, polymethacrylic acid potassium salt, polyacrylic acid cesium salt, polymethacrylic acid cesium salt, polyacrylic rubidium salt, polymethacrylic rubidium salt, polyacrylic acid ammonium salt, polymethacrylic acid ammonium salt, polyacrylic acid tetramethylammonium salt, polymethacrylic acid tetramethylammonium salt, polyacrylic acid trimethylammonium salt, polymethacrylic acid trimethylammonium salt, polyacrylic acid tetraethylammonium salt, polymethacrylic acid tetraethylammonium salt, polyacrylic acid mopholinium salt, polymethacrylic acid mopholinium salt, polyacrylic acid imidazolium salt, polymethacrylic acid imidazolium salt, polyacrylic acid pyridinium salt, polymethacrylic acid pyridinium salt, and mixtures thereof.

11. The composition of claim 1, further comprising at least one member selected from the group consisting of anti-clogging agents, polymeric additives, anti-curl agents, humectants, biocides, anti-bleed agents and pH buffering agents.

12. An ink jet ink set comprising:
a plurality of inks, wherein at least one ink is the ink composition of claim 1.

13. The ink set of claim 9, wherein at least two inks are the ink composition of claim 1.

14. An ink jet printing process comprising:
printing a first ink comprising the ink jet ink composition according to claim 1 onto a substrate; and
printing a second ink onto the print substrate.

15. The process of claim 14, wherein the first ink is printed onto the print substrate before the second ink is printed onto the substrate.

16. The process of claim 14, wherein the second ink is printed onto a surface of the print substrate before the first ink is printed onto the surface of the print substrate.

17. The process of claim 14, wherein the first ink is a color ink.

18. The process of claim 14, wherein the second ink a black ink.

19. A multicolor ink jet printing process comprising:
incorporating into an ink jet printer a first ink jet ink composition comprising an inter-color bleed additive;
incorporating into the ink jet printer at least one second ink;
causing droplets of said first ink to be ejected in an imagewise pattern onto a surface of a print substrate; and
causing droplets of said at least one second ink to be ejected in an imagewise pattern onto the surface of the print substrate so that a multicolor ink image is formed on the print substrate that exhibits minimal intercolor bleed and MFLEN
wherein the inter-color bleed additive is an acid or salt thereof, the acid having at least one pendant carboxylic acid group or at least one pendant carboxylate group.

20. The process of claim 19, wherein said first ink is ejected onto the surface of the print substrate prior to ejecting said at least one second ink onto the surface of the print substrate.

21. The process of claim 19, wherein said at least one second ink is ejected onto the surface of the print substrate before ejecting the first ink onto the surface of the print substrate.

22. The process of claim 19, further comprising jetting at least one of the ink through a printhead capable of printing at least 360 spots per inch.

23. The process of claim 19, wherein at least some of said first ink is printed on top of said at least one second ink.

24. The process of claim 19, wherein at least some of said at least one second ink is printed on top of said first ink.

25. The process of claim 19, wherein said first ink is selected from the group consisting essentially of a yellow ink, a cyan ink and a magenta ink.

26. The process of claim 19, wherein said inter-color bleed additive is selected from the group consisting essentially of polyacrylic acid lithium salt, polymethacrylic acid lithium salt, polyacrylic acid sodium salt, polymethacrylic acid sodium salt, polyacrylic acid potassium salt, polymethacrylic acid potassium salt, polyacrylic acid cesium salt, polymethacrylic acid cesium salt, polyacrylic rubidium salt, polymethacrylic rubidium salt, polyacrylic acid ammonium salt, polymethacrylic acid ammonium salt, polyacrylic acid tetramethylammonium salt, polymethacrylic acid tetramethylammonium salt, polyacrylic acid trimethylammonium salt, polymethacrylic acid trimethylammonium salt, polyacrylic acid tetraethylammonium salt, polymethacrylic acid tetraethylammonium salt, polyacrylic acid mopholinium salt, polymethacrylic acid mopholinium salt, polyacrylic acid imidazolium salt, polymethacrylic acid imidazolium salt, polyacrylic acid pyridinium salt, polymethacrylic acid pyridinium salt, and mixtures thereof.

27. The process of claim 19 wherein said inter-color bleed additive is a salt of a counter ion selected from the group consisting essentially of H⁺, Li⁺, Na⁺, K⁺, Rb⁺ and Cs³⁰ , Be²⁺, Mg²⁺, Ca²⁺, Sr²⁺, Ba²⁺, and substituted or unsubstituted ammonium ions.
